(19) United States
(12) Patent Application Publication
(10) Pub. No.: US 2004/0262359 A1
(43) Pub. Date: Dec. 30, 2004

(54) Urban utility belt

(76) Inventors: Melissa J. DeVolentine, Miami Beach, FL (US); Mirtha G. Cortes, San Juan, PR (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/816,655

(22) Filed: Apr. 2, 2004

Related U.S. Application Data
(63) Continuation-in-part of application No. 10/042,115, filed on Oct. 19, 2001, now abandoned.
(60) Provisional application No. 60/241,591, filed on Oct. 19, 2000.

(51) Int. Cl. B60C 5/16; B60C 15/06; A45C 1/04; A45F 3/00; F41C 33/02; F42B 39/02

(52) U.S. Cl. 224/665; 224/682

(57) ABSTRACT

A belt and case assembly for holding and supporting items for a user is disclosed, including an outer belt surface, an inner belt surface opposite the outer belt surface, a plurality of first components of a dual component directional snap fastener traversing the outer belt surface and engaging the inner belt surface, and a case having a flexible side, wherein the flexible side incorporates a plurality of second components of the dual component directional snap fastener to form a plurality of engagements to the plurality of first components, the plurality of second components positioned with respect to one another so as to prevent rotational movement of the case about said belt, the plurality of engagements decoupled by a force applied in a predetermined direction at a first position of the first component.

### CROSS-REFERENCES TO RELATED APPLICATIONS

This application is a Continuation-In-Part of U.S. Nonprovisional patent application Ser. No. 10/042,115, filed on October 19 2001, entitled URBAN UTILITY BELT, which claims the benefit of U.S. Provisional Application Ser. No. 60/241,591, filed on Oct. 19, 2000, entitled URBAN UTILITY BELT.

### TECHNICAL FIELD

The present invention relates generally to a device for holding and supporting items and things in close proximity to a wearer's or user's body. More specifically, the present invention relates to a belt, around a user's waist or torso, to releaseably support at least one case for holding a myriad of items including, but not limited to a personal digital assistant, a notebook computer, a cellular phone, a beeper, a change purse, sunglasses case, protective devices, e.g., mace, CD players, MP3 players, paper products, writing utensils, wallet and keys.

### BACKGROUND OF THE INVENTION

The present invention is a device for holding and supporting items and things in close proximity to a wearer's or user's body. Specifically, a belt, around a user's waist or torso, is used to support a myriad of items including, but not limited to a personal digital assistant, a notebook computer, a cellular phone, a beeper, a change purse, sunglasses case, protective devices, e.g., mace, CD players, MP3 players, paper products, writing utensils, wallet and keys. Many of these items can also be held in a case that is releasably attached to the belt by closure elements. In this way, the held items can be readily accessible and usable by the wearer/user.

The cases are and can each be individually designed to support the held items, to allow easy access to the items, so that they can easily be removed from the case and/or that the case can be easily removed from and replaced to and from the belt while worn by the user. In addition, the closure elements that secure the case to the belt are selectively releasable from one another, thereby permitting the wearer to position the any one of numerous desired types of cases to be placed on the belt at a variety of positions. Moreover, the positions of the cases on the belt may be defined by the wearer.

The utility belts of the prior art include tool bags that are available with removable or interchangeable pouches or other holders secured by fasteners. Generally, the utility belts of the prior art were restricted to attachment and removal of the cases only upon the wearer's removal of the belt.

These tool bags have a severely limited range of adjustability and the pouches or holders can readily be removed from the belt without the intended participation of the user, resulting in the unintended dropping or theft of the cases. This is a particular problem when the wearer is in a crowded place. Additionally, other similar tool holding devices, such as holsters, have been constructed to rotate at the point of attachment (for example, a snap fastener) so as to travel with the momentum generated by the movements of the user.

Accordingly, there is a need for a utility belt for holding and supporting personal items that includes dual component directional snap fasteners that permit the wearer to securely fasten and release cases for attachment to the belt to form a case and belt assembly, while substantially reducing the unintended removal of the cases and preventing rotational movement of the case about the belt as a result of the momentum produced by the wearer.

### OBJECTS OF THE INVENTION

It is an object of the present invention to provide a belt for holding and supporting personal items that includes dual component directional snap fasteners that permit the wearer to securely fasten and release cases for attachment to the belt to form a case and belt assembly, the dual component directional snap fastener capable of being decoupled only by a force applied in a predetermined direction, substantially reducing the unintended removal of the cases.

It is an object of the present invention to provide a belt worn by a user to support items to be used by the user, including cases that hold or support other items, the belt capable of supporting numerous cases at a given time.

It is another object of the present invention for the dual component directional snap fasteners prevent rotational movement of the case about the belt as a result of the momentum produced by the wearer.

It is another object of the present invention that dual component directional snap fasteners on the belt and on the case be attractive, fashionable, and yet functional to allow secure attachment and release of the case by the user so that the attached items will not be dropped, lost, misplaced or otherwise inadvertently separated from the user.

It is another object of the present invention to provide a method for fastening and releasing a case and belt assembly.

### SUMMARY OF THE INVENTION

The present invention eliminates the above-mentioned needs by providing a belt and case assembly for holding and supporting items for a user is disclosed, including an outer belt surface, an inner belt surface opposite the outer belt surface, a plurality of first components of a dual component directional snap fastener traversing the outer belt surface and engaging the inner belt surface, and a case having a flexible side, wherein the flexible side incorporates a plurality of second components of the dual component directional snap fastener to form a plurality of engagements to the plurality of first components, the plurality of second components positioned with respect to one another so as to prevent rotational movement of the case about said belt, the plurality of engagements decoupled by a force applied in a predetermined direction at a first position of the first component.

The present invention is additionally directed to a method for fastening and releasing a case and belt assembly, including providing a belt having a plurality of first components of a dual component directional snap fastener, wherein the dual component directional snap fastener cannot be decoupled except by a force applied in a predetermined direction at a first position of the first component, coupling a case having a plurality of second components of the dual component directional snap fastener to the plurality of first components on the belt to form the case and belt assembly, the coupling preventing rotational movement of the case about said belt, and decoupling the case from the belt by applying the force in the predetermined direction at the first position of the first component.

### BRIEF DESCRIPTION OF THE DRAWINGS

FIG. 1 is a perspective view of a person, a user/wearer of the present invention, showing the belt with several attached items, with the belt around the wearer's waist.

FIG. 2 is a front view of the belt of the present invention shown with several first components of a dual component directional snap fastener for receiving items to be attached to the belt.

FIG. 2a is a front view of an alternate embodiment of the present invention.

FIG. 3 is a rear view of an item case showing the second component of the dual component directional snap fasteners and the zipper closure of the case.

FIG. 4 is a rear view of another item case showing the second component of the dual component directional snap fastener and the flap closure of the case.

FIG. 5 is a perspective of another item case showing the second component of the dual component directional snap fastener and the flap closure of the case.

FIG. 6 is a cross-sectional view of the item case shown in FIG. 5.

FIG. 7 is a perspective view of an item that is selectively releasably coupled directly to the belt.

FIG. 8 is a front view of a section of the belt with several first components of dual component directional snap fasteners.

FIG. 9 is a perspective view of a person, a user/wearer of the present invention, showing the belt with several attached items, with the belt around the wearer's upper torso.

### DESCRIPTION OF ILLUSTRATIVE PREFERRED EMBODIMENTS

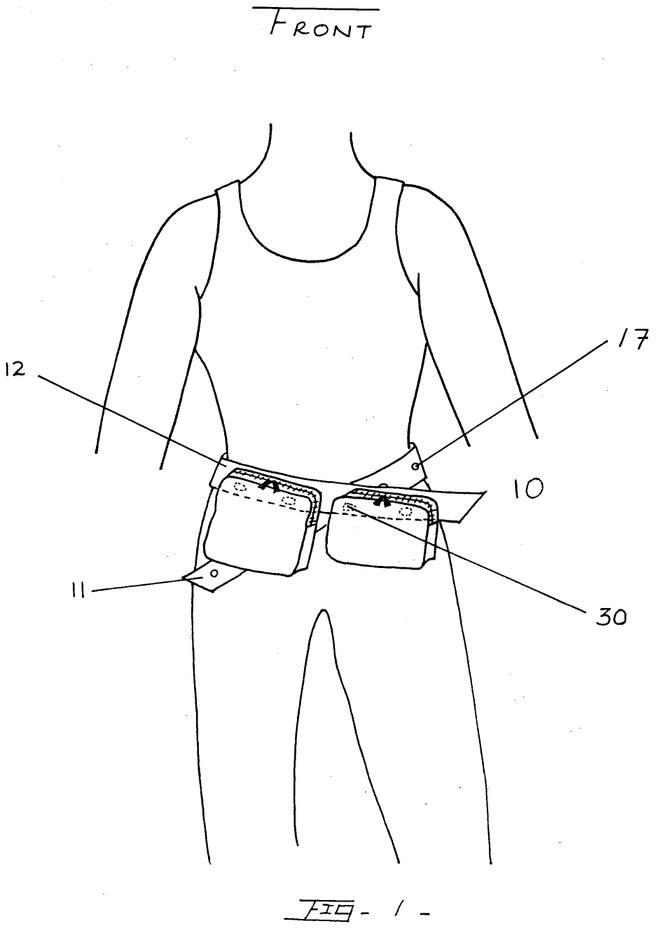

Referring now to FIG. 1, the preferred embodiment of the present invention is illustrated as accessory belt and case assembly 10, worn on a user's body for holding thereon, preferably the waist or upper torso, one or more items. Belt 11 is typically made of leather, but can be made of other materials or combinations of materials as is known in the art. Belt 11 would typically be worn in the area of a wearer's waist 12, but may be worn higher, lower or on other areas of the wearer's body in order for belt 11 to comfortably support, on the wearer's body, the desired items.

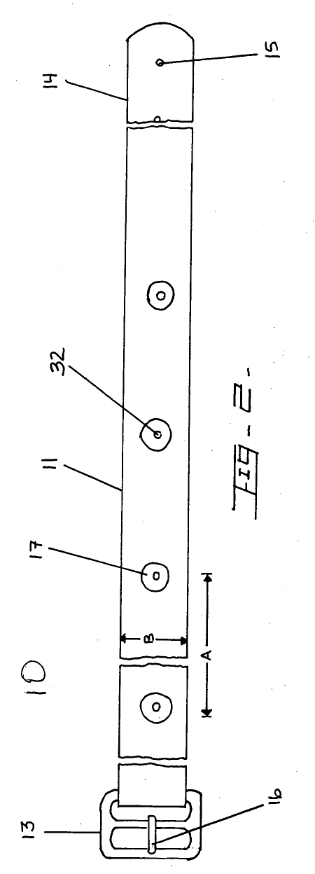

Referring now to FIG. 2, belt 11 is elongated having two ends. Buckle 13 is at one end and belt tongue 14 at the other end. The latter, tongue 14 designed as well known in the art, to fit within the former, buckle 13 in order to buckle belt 11 in place. Belt tongue 14 has one or more belt tip holes 15 for engagement with buckle stick 16 of buckle 13. FIG. 2a shows an alternate embodiment of the belt 11. The belt 11 has fasteners 11a spaced an equal distance apart from an adjacent fastener 11a to engage the ends of the belt together. In the preferred embodiment, each of the fasteners 11a is spaced approximately 1¼ inches center to center. One or more first components 17 of a dual component directional snap fastener are formed on or otherwise securely attached to belt 11. The dual component directional snap fastener is a selectively releasable closure element, preferably a curtain-type fastener or a locking snap. A dual component directional snap fastener is most preferred because it locks on three sides of first component 17, unlocking only by moving a corresponding second component (such as second component 30) in a predetermined motion, such as lifting the second component along a particular location of first component 17. A typical snap fastener or hook and loop fastener, as used in the prior art, is unacceptable due to the ease in which the case is removed, thereby facilitating unintended removal. In this preferred embodiment, the belt 11 receives a first component 17 of a selectively releasable closure element; such that first component 17 traverses the outer layer 18 of the belt 11 and engages the inner layer 19 of the belt 11. One or more first components 17 are arranged along the length of belt 11 such that each first component 17 is spaced an equal distance from an adjacent first component 17.

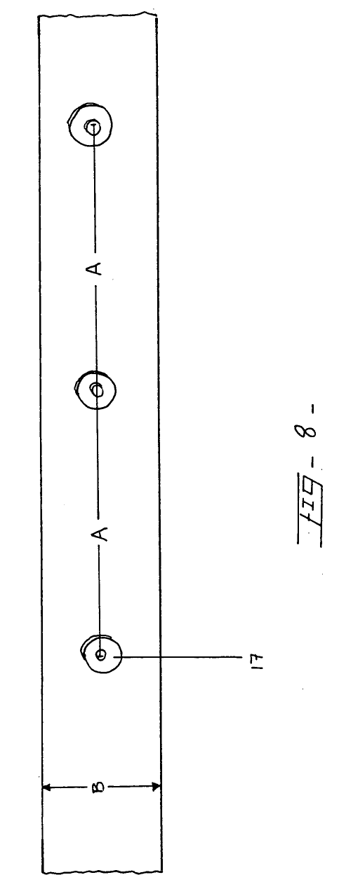

In the preferred embodiment each first component 17 is spaced a distance of approximately 3½ inches center to center but preferably not less than 3 inches or greater than 4 inches from the next first component 17. This distance provides ample support for items to be held at two points as will be discussed later herein. This distance is shown in FIGS. 2 and 8 as a distance “A”. Additionally, first components 17 are located at the approximate center of the vertical height “B” of belt 11.

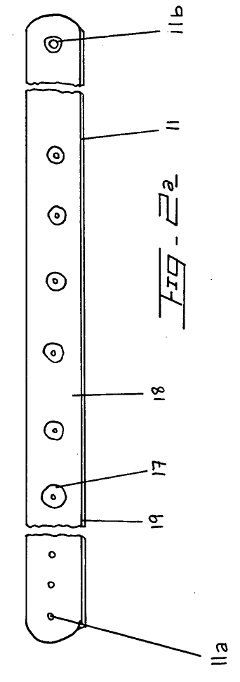

Items to be held to belt 11 include cases that hold items and actual items. Referring to FIG. 3, is a zippered case 20 to hold, for example, compact disc players or other miscellaneous items. Zipper 21 includes a pull tab 21a, shown in the closed position that provides access to said zippered case 20. An access slot 22 is provided to allow the user to access the interior of the case, such as with headphones for a compact disc player.

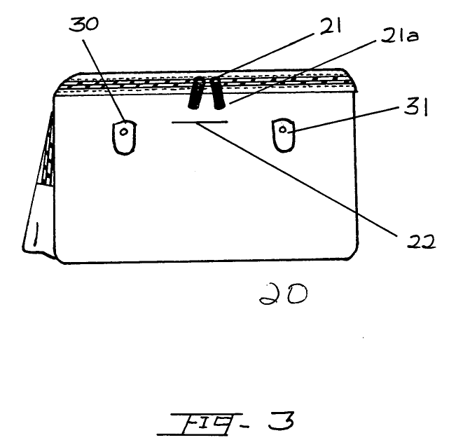

FIG. 4 shows a case, such as a pouch 23 having a flap closure 24, held closed by a hook and loop fastener means or snap fastener means (not shown). The cases of the present invention, such as pouch 23, are preferably removable from the belt while the belt is worn by the user. Pouch 23 may hold numerous personal items, including but not limited to a personal digital assistant type device or a pair of sunglasses. Pouch 23 has sides 23a and 23b that are flexible to expand and adapt to the size of the item to be stored therein. Pouch 23 may also include access slot 22.

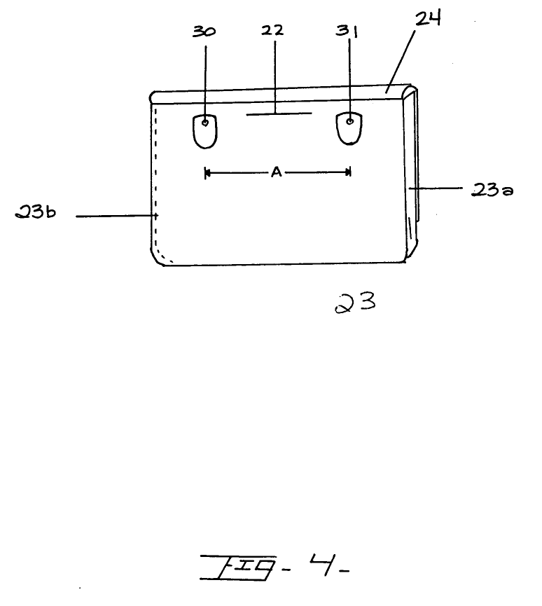

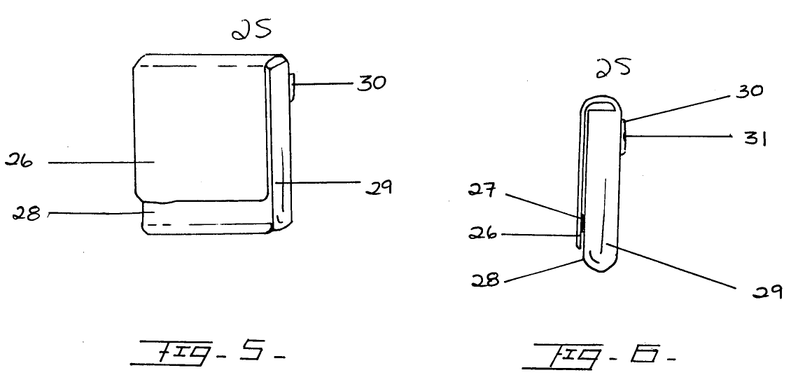

FIGS. 5 and 6 show another case such as a case 25. This case 25 can hold different items, depending on their size and shape, e.g., a portable wireless telephone or a wireless pager. Case 25 is of generally rigid construction having a closure flap 26 attached by a snap fastener means 27 to the front side 28 of case 25. Interior solid walls 29 of case 25 and flap 26 give case 25 its rigidity.

Each case item 20, 23 and 25 is selectively releasably coupleable to belt 11 by one or more second components 30 of the dual component directional snap fastener. Each second component 30 is adapted to receive a male end 32 of the first component 17 by interlocking to a female end 31 on the second component 30. At approximately the mid-point of second component 30 is female end 31. Second component 30 is integrally connected to a rear portion of each case item, such as a case 20, pouch 23 or case 25, in a permanent manner or at least intended to be permanent. As is shown in FIGS. 3, 4, 5 and 6, second component 30 is attached at the top of a case e.g., the case 20, the pouch 23, and the case 25, at or near the top-rear thereof.

The selectively releasable coupling is accomplished by engaging first component 17 to second component 30 of the dual component directional snap fastener, with its interlocking first component 17 and second component 30. Thus, at the desired locations of the upper component of each case 20, 23 and 25, second component 30 is attached to case 20, 23 or 25 through a rear component 30 of each case at each respective selectively releasable coupling location. Each case may be made of leather or other material or materials. Each case has more than one second component 30 attached to thereto. When more than one second component 30 is attached to a case, each second component 30 is separated from the next second component 30 by the same distance “A” as first components 17 are separated on belt 11. Utilizing more than one second component 30 of the dual component directional snap fastener on a case prevents the case from rotating about the belt, eliminating undesired movement of the case and items contained therein.

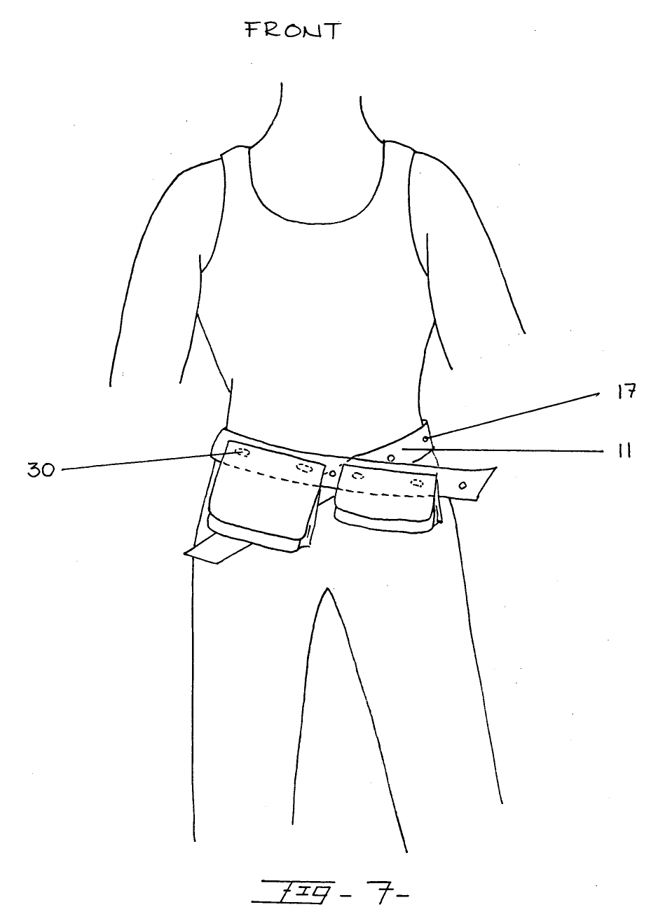

As shown in FIGS. 1, 7, and 9, a case is attached to belt 11 by interlocking a female end 31 of each second component 30 from the case to a first component 17 on belt 11. Female end 31 has a diameter such that second component 30 will stay connected to the male end 32 of first component 17. When it is desired to separate a case from belt 11, the user performs the action to apply a force in a predetermined direction at first component 17 and thus disengages the interlocking arrangement of first component 17 and second component 30 of the dual component directional snap fastener so as to release second component 30 from first component 17. With at least two attachment points on an item or case, rotational movement about belt 11 is prevented and redundancy is provided to retain the case in the event one of said second components 30 should become loosened or detached from a first component 17. It is contemplated that the belt 11 may incorporate second components 30 with female ends thereon and that the cases may incorporate first components 17 with male ends 32 thereon.

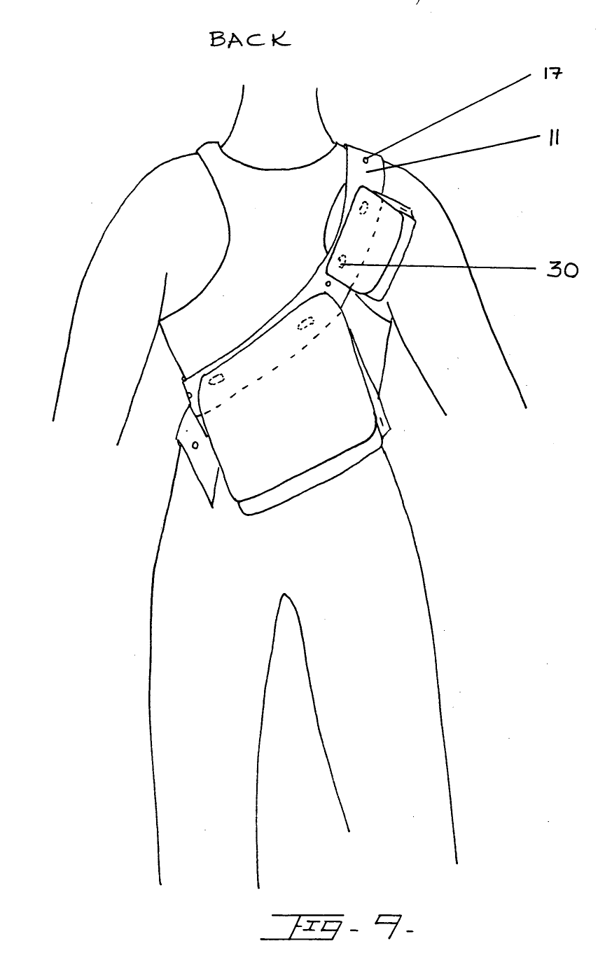

In an alternative embodiment, as shown in FIG. 9, the user wears the belt 11 over the shoulder, so as to enable the user to carry larger or more cumbersome items, such as notebook computers, or for personal comfort.

Second components 30 are selectively releasably coupled to the belt. The selectively releasable coupling may be disengaged by the user by manipulating first component 17 with respect to second component 30 of the dual component directional snap fastener, or selectively releasable closure element, in a specific predetermined motion that is particular to the dual component directional snap fastener as discussed herein.

In summary, the present invention is a belt on a person's torso for supporting and releasably holding one or more items which would include a case to hold an object or objects therein, the cases to be supported on the belt by a dual component directional snap fastener having first components with male ends spaced at equal distances from one another and second components with female ends on the cases having the same spaced distance between the second components so that a second component can be selectively releasably and securely coupled at any available location on the belt.

While the preferred embodiment of the present invention has been described in detail above, those skilled in the art will readily appreciate that numerous modifications are to the exemplary embodiment is possible without materially departing from the novel teachings and advantages of this invention. Accordingly, all such modifications are intended to be included within the scope of this invention as defined in the following claims.

What is claimed is:

1. A belt and case assembly for holding and supporting items for a user comprising:
an outer belt surface;
an inner belt surface opposite said outer belt surface;
a plurality of first components of a dual component directional snap fastener traversing said outer belt surface and engaging said inner belt surface; and
a case having a flexible side, wherein said flexible side incorporates a plurality of second components of said dual component directional snap fastener to form a plurality of engagements to said plurality of first components, said plurality of second components positioned with respect to one another so as to prevent rotational movement of said case about said belt, said plurality of engagements decoupled by a force applied in a predetermined direction at a first position of said first component.

2. The belt and case assembly according to claim 1 wherein said case stores items including, but not limited to personal digital assistants, notebook computers, wireless telephones, wireless pagers, portable music players, software, paper products, writing utensils, change purses, wallets, eyewear, protective devices, and keys.

3. The belt and case assembly according to claim 1 wherein said case further includes a closure.

4. The belt and case assembly according to claim 3 wherein said closure comprises a flap cover or a zipper.

5. The belt and case assembly according to claim 4 wherein said flap cover releasably engages said case.

6. A method for fastening and releasing a case and belt assembly, comprising:
providing a belt having a plurality of first components of a dual component directional snap fastener, wherein said dual component directional snap fastener cannot be decoupled except by a force applied in a predetermined direction at a first position of said first component;
coupling a case having a plurality of second components of said dual component directional snap fastener to said plurality of first components on said belt to form said case and belt assembly, said coupling preventing rotational movement of said case about said belt; and
decoupling said case from said belt by applying said force in said predetermined direction at said first position of said first component.
